(19) United States
(12) Patent Application Publication
(10) Pub. No.: US 2007/0171893 A1
(43) Pub. Date: Jul. 26, 2007

(54) Inter-domain routing method for a dual-mode terminal, registration system and method, gateway and signaling forking function

(75) Inventors: Jie Xu, Shenzhen (CN); Wenyu Liu, Shenzhen (CN); Fang You, Shenzhen (CN)

Correspondence Address: MCDERMOTT WILL & EMERY LLP, 600 13TH STREET, N.W., WASHINGTON, DC, 20005-3096, US

(73) Assignee: HUAWEI TECHNOLOGIES CO., LTD.

(21) Appl. No.: 11/490,009

(22) Filed: Jul. 19, 2006

(30) Foreign Application Priority Data
Jul. 19, 2005 (CN) 200510027891.0

(51) Int. Cl. H04L 12/66; H04L 12/56

(52) U.S. Cl. 370/352; 370/401

(57) ABSTRACT

The present invention discloses an inter-domain routing method for a dual-mode terminal, and a registration system and method. In the present invention, with an inter-domain IWGW, the dual-mode terminal registers respectively with the IWGW when it logins in the circuit domain or the packet domain; a GMSC or CSCF triggers to the IWGM upon receipt of a call for the terminal; the IWGW decides the route according to the registration state and a predefined policy; and the GMSC or CSCF continues the call according the decision result. A practical policy is to route the call to a domain where the terminal has a latest registration. A SFF is added between the HLR and the VLR, for duplicating and forwarding the interaction signaling between the VLR and the HLR to the IWGW. The present invention also discloses an Interwork Gateway and a Signaling Forking Function.

### RELATED APPLICATION

This application claims the benefit of priority from Chinese patent application No. 200510027891.0, filed Jul. 19, 2005, the disclosure of which is hereby incorporated herein by reference in its entirety.

### FIELD OF THE INVENTION

The present invention relates to the communication technologies for dual-mode terminals, and particularly to an inter-domain routing method for a dual-mode terminal and a registration system, a registration method, a gateway and a signaling forking function.

### BACKGROUND OF THE INVENTION

In recent years, communication technologies have been developing rapidly and swiftly. The Second Generation (2G) mobile communication systems are digital communication systems mainly transporting voice and data, in which the low-rate data service and the short message service, in addition to the voice communication service, are provided. Typical 2G systems include the Global System for Mobile Communication (GSM) utilizing the Time Division Multiple Access (TDMA), etc.

As the voice communication and the multimedia communication may be integrated in the Third Generation (3G) mobile communication, its possible value-added services may include information services of image, music, webpage browsing, videoconference and the like. However, since the 3G is a vast project that involves various complicated aspects, it seems impossible for a fast transition from the 2G to the 3G. In this case, there emerges the 2.5G which is between the 2G and the 3G. The 2.5G mobile communication technologies, which are available commercially at present, are the transitional technologies during the transition from the 2G to 3G. Typical 2.5G systems include the Code Division Multiple Access (CDMA) 2000 1X.

Currently, the networks with the broadest coverage are the circuit networks of 2G or 2.5G.

In addition, the wideband wireless communication technology has also been developing rapidly in recent years, which brings increasingly convenience to our daily life and work. Typical wideband wireless networks include the Wireless Local Area Network (WLAN) and the High Rate Packet Data (HRPD), which is also referred to as the CDMA 2000 EVDO (Evolution Data Only).

A brief introduction of the CDMA 2000 EVDO will be given below.

The DO, i.e. Data Only, means the technology supports only a data service, and do not support a voice service, which aims mainly to improve the data transmission rate for a wireless interface. The EVDO adopts a new modulation technology and introduces the methods of data rate control, scheduling optimization, time division multiplexing and the like over an air interface, so that the data transmission over the air interface can be improved significantly. In comparison with the CDMA 2000 1X, the CDMA 2000 EVDO has two major advantages: a high peak rate, and a large capacity supporting a huge number of users. The CDMA 2000 EVDO can be applied widely in services of visual phone, stream media and data broadcast.

Presently, operators may superimpose a wireless wideband network over the 2G or 2.5G network at some hotspots in order to provide the users with better services, that is, a larger bandwidth and a higher access rate. Behind these wideband services, generally, it is the Internet Protocol Multimedia Subsystem (IMS) that provides various versatile multimedia services.

In such a case, there exist some dual-mode terminals such as a dual-mode mobile phone. A dual-mode terminal has a most important function of selecting its service network, i.e. its access mode. For example, it is possible to switch from the 2.5G CDMA 2000 1X network to the wireless wideband CDMA 2000 EVDO network. That is to say, it is possible not only to have an access to a wireless wideband network at a hotspot, but also to access a common voice service through a conventional wireless cellular circuit-domain network, such as the CDMA 2000 1X, the GSM or the like, at a location without the wireless wideband network.

In the 2G or 2.5G network over which the wireless wideband network is superimposed, a user may access to any one of the networks, and therefore it is necessary to solve the problem of how to decide from which network to call the user in the case that a call is needed to be connected to the user. It shall be also taken into account the problem that a current terminal can not accesses to the wideband wireless network and the 2G or 2.5G network simultaneously, for example, the CDMA 2000 EVDO and the CDMA 2000 1X, the WLAN and the CDMA 2000 1X, etc.

At present, a solution has been proposed, in which a new network entity of Domain Routing Function (DRF) is disposed between an IMS domain and a Circuit Switching (CS) domain is adopted to simulate the function of a Visitor Location Register (VLR).

Referring to FIG. 1, when a user registers in an IMS domain (step 101), a network entity DRF, which is in place of an IMS domain, initiates a location registration process with a Home Location Register (HLR) in a CS domain (step 110).

Referring to FIG. 2, when the user roams to the CS domain, the HLR sends a location cancel message to the DRF which simulates the function of the VLR (step 203), and the DRF deregisters the user in the Home Subscriber Server (HSS) in the IMS domain (steps 206 to 209).

In the above solution, the user can be kept in registration state in only one network at a time, while being kept in deregistration state in the other network. That is to say, the user can not be kept in registration state in both of the networks at the same time, and thus the extent of services available to the user may be limited.

However, some wireless access technologies allow a user to access two different networks simultaneously, for example, the WLAN and the WCDMA, the packet domain and the circuit domain of the WCDMA, etc. In addition, a terminal may be required to have simultaneous accesses to the wideband wireless network and the 2G or 2.5G network, such as, the CDMA 2000 EVDO and the CDMA 2000 1X, the WLAN an the CDMA 2000 1X, etc. In this case, a user restricted to a certain network may fail to share various services of another domain.

In the prior art, for example, when a user only registers in an IMS, and a short message is sent from a CS domain, this short message has to be converted into the format of the IMS domain via a short message gateway so as to be sent from the IMS domain to the user, which processing is rather complicated.

### SUMMARY OF THE INVENTION

An embodiment of the present invention provides an inter-domain routing method for a dual-mode terminal between a circuit domain which enables a user to be kept in registration state and access services simultaneously in both of the circuit domain and the packet domain.

The present invention also provides a registration system, a registration method, an Interwork Gateway and a Signaling Dorking Function corresponding to the inter-domain routing method.

An inter-domain routing method for a dual-mode terminal between a circuit domain and a packet domain, including the steps of:
obtaining registration information by an Interwork Gateway when the terminal registers in the circuit domain or the packet domain;
triggering a call for the terminal to the Interwork Gateway when a device in the circuit domain or the packet domain receives the call;
making a route decision by the Interwork Gateway according to the registration information and a predefined policy; and
continuing the call when the device in the circuit domain or the packet domain receives the decision from the Interwork Gateway.

Optionally, after the step of making the route decision, the method may further include the steps of:

in the case that the terminal has a latest registration in the circuit domain and the call comes from the packet domain, obtaining a Temporary Local Directory Number of the terminal from a Home Location Register by the Interwork Gateway after the Interwork Gateway is triggered by a Call Session Control Function, and reinitiating a request, in which the requested address is the Temporary Local Directory Number of the terminal, by the Interwork Gateway acting as a Back to Back User Agent.

Optionally, after the step of making the route decision, the method may further include the steps of:
modifying the called number of the call into an access number of the Interwork Gateway and returning the modified number to a Gateway Mobile Switching Centre after the Interwork Gateway is triggered by the Gateway Mobile Switching Centre, in the case that the terminal has a latest registration in the packet domain and the call comes from the circuit domain; and

the step of continuing the call includes the steps of:
associating this call with the call triggered by the Gateway Mobile Switching Centre, and initiating a new request to the terminal by the Interwork Gateway acting as a Back to Back User Agent, when the call is routed to the Interwork Gateway by the Call Session Control Function:

Optionally in the method, the associating may be performed by the Interwork Gateway through a calling number field of the call or a predesignated field in a call message.

Optionally, after the step of making the route decision, the method may further include the steps of
returning an instruction of continuing the connection in the CS domain by the Interwork Gateway after the Interwork Gateway is triggered by a Gateway Mobile Switching Centre, in the case that the terminal has a latest registration in the circuit domain and the call comes from the circuit domain.

Optionally in the method, the step of continuing the call may include the steps of:
obtaining a Temporary Local Directory Number, which is assigned by a Visited Network Mobile Switching Centre in which the user terminal is located, by the Gateway Mobile Switching Centre through a user Home Location Register when the Gateway Mobile Switching Centre receives the instruction of continuing the connection in the CS domain, and connecting the call to the Visited Network Mobile Switching Centre which connects to the user in the circuit domain.

Optionally in the method, the packet domain may be an Internet Protocol Multimedia Subsystem domain.

Optionally in the method, the predefined policy may be an operator policy, or a user policy, or a combination of an operator policy and a user policy.

Optionally in the method, the operator policy or the user policy may be to route the call to a domain where the terminal has a latest registration.

Optionally in the method, the registration of the terminal in the circuit domain may include the steps of:
during the registration, obtaining by the Interwork Gateway a message which is transmitted between a Visitor Location Register and a Home Location Register, and extracting and recording the user registration information if the message contains information related to the user registration; or
obtaining and recording by the Interwork Gateway information related to the user registration contained in a message which is transmitted between a Visitor Location Register and a Home Location Register.

Optionally, in the method, a Signaling Forking Function may be added over a signaling link between a Visitor Location Register and a Home Location Register in the circuit domain, for duplicating a received message and forwarding the duplicated message to the Interwork Gateway; and

the registration of the terminal in the circuit domain may include the steps of:
during the registration, forwarding a message, which is sent from the Visitor Location Register to the Home Location Register, to the Home Location Register in the case that the Signaling Forking Function intercepts the message, duplicating the message and forwarding the duplicated message to the Interwork Gateway;
during the registration, forwarding a message, which is sent from the Home Location Register to the Visitor Location Register, to the Visitor Location Register in the case that the Signaling Forking Function intercepts the message, duplicating the message and forwarding the duplicated message to the Interwork Gateway; and
extracting and recording the user registration information, when the Interwork Gateway receives the message of the terminal from the Signaling Forking Function.

Optionally, in the method, a Signaling Forking Function is added over a signaling link between a Visitor Location Register and a Home Location Register in the circuit domain, for selecting a message containing information related to the user registration among the received messages, duplicating the message and forwarding the duplicated message to the Interwork Gateway; and

the registration of the terminal in the circuit domain may include the steps of:
during the registration, forwarding a message, which is sent from the Visitor Location Register to the Home Location Register, to the Home Location Register if the Signaling Forking Function intercepts the message, determining whether the message contains information related to the user registration, and if yes, duplicating the message and forwarding the duplicated message to the Interwork Gateway;
during the registration, forwarding a message, which is sent from the Home Location Register to the Visitor Location Register, to the Visitor Location Register in the case that the Signaling Forking Function intercepts the message, determining whether the message contains information related to the user registration, and if yes, duplicating the message and forwarding the duplicated message to the Interwork Gateway; and
extracting and recording the user registration information by the Interwork Gateway when the Interwork Gateway receives the message of the terminal from the Signaling Forking Function.

Optionally, in the method, a Signaling Forking Function is added over a signaling link between a Visitor Location Register and a Home Location Register in the circuit domain, for extracting user registration information upon the receipt of a message and for informing the Interwork Gateway of the extracting result; and

the registration of the terminal in the circuit domain may include the steps of:
during the registration, forwarding a message, which is sent from the Visitor Location Register to the Home Location Register, to the Home Location Register if the Signaling Forking Function intercepts the message, determining whether the message contains information related to the user registration, and if yes, extracting the user registration information and informing the Interwork Gateway of the extracting result;
during the registration, forwarding a message, which is sent from the Home Location Register to the Visitor Location Register, to the Visitor Location Register in the case that the Signaling Forking Function intercepts the message, determining whether the message contains information related to the user registration, and if yes, extracting the user registration information and informing the Interwork Gateway of the extracting result; and
recording the user registration result by the Interwork Gateway when the Interwork Gateway receives the user registration information from the Signaling Forking Function.

Another embodiment of the present invention provides a system for obtaining registration information of a user in a circuit domain, including a Home Location Register, a Visitor Location Register and a third-party device which needs to obtain the registration information, wherein the system further includes a Signaling Forking Function in a signaling link connected between the Visitor Location Register and the Home Location Register, for sending data including the registration information to the third-party device according to a predefined policy while transmitting an interaction message transparently between the Visitor Location Register and the Home Location Register.

Optionally, the predefined policy may be one of:
the Signaling Forking Function duplicating all the received messages and forwarding them to the third-party device, among which the third-party device selects a registration-related message;
the Signaling Forking Function selecting a registration-related message among received messages, and duplicating this message and forwarding the duplicated message to the third-party device; and
the Signaling Forking Function parsing the received messages and forwarding the obtained registration information to the third-party device.

Optionally in the system, the third-party device may be an Interwork Gateway; and

the third-party device and the Signaling Forking Function may be located in the same physical entity or two separate physical entities.

Still another embodiment of the present invention provides a method for obtaining registration information of a user in a circuit domain in the above system, including the steps of:
transmitting a message, which is sent from the Visitor Location Register to the Home Location Register, transparently to the Home Location Register when a Signaling Forking Function intercepts the message, and duplicating the message and forwarding the duplicated message to a third-party device;
transmitting a message, which is sent from the Home Location Register to the Visitor Location Register, transparently to the Visitor Location Register when the Signaling Forking Function intercepts the message, and duplicating the message and forwarding the duplicated message to the third-party device; and
determining by the third-party device whether the message contains information related to the user registration when the third-party device receives the message from the Signaling Forking Function, and if yes, processing the message.

A further embodiment of the present invention provides a method for obtaining registration information of a user in a circuit domain in the above system, including steps of:
transmitting a message, which is sent from the Visitor Location Register to the Home Location Register, transparently to the Home Location Register when the Signaling Forking Function intercepts the message, determining whether the message contains information related to the user registration, and if yes, duplicating the message and forwarding the duplicated message to the third-party device; and
transmitting a message, which is sent from the Home Location Register to the Visitor Location Register, transparently to the Visitor Location Register when the Signaling Forking Function intercepts the message, determining whether the message contains information related to the user registration, and if yes, duplicating the message and forwarding the duplicated message to the third-party device.

A still further embodiment of the present invention provides a method for obtaining in the above system registration information of a user in a circuit domain, including steps of:
forwarding a message, which is sent from the Visitor Location Register to the Home Location Register, to the Home Location Register when the Signaling Forking Function intercepts the message, determining whether the message contains information related to the user registration, and if yes, extracting the user registration information and informing the third-party device of the extracting result; and
forwarding a message, which is sent from the Home Location Register to the Visitor Location Register, to the Visitor Location Register when the Signaling Forking Function intercepts the message, determining whether the message contains information related to the user registration, and if yes, extracting the user registration information and informing the third-party device of the extracting result.

Further, an embodiment of the present invention provides a Signaling Forking Function including:
a first message intercepting unit for intercepting a message sent from a Visitor Location Register to a Home Location Register, transmitting the message transparently to the Home Location Register, duplicating the message and forwarding the duplicated message to a third-party device; and
a second message intercepting unit for intercepting a message sent from the Home Location Register to the Visitor Location Register, transmitting the message transparently to the Visitor Location Register, duplicating the message and forwarding the duplicated message to a third-party device.

Furthermore, an embodiment of the present invention provides a Signaling Forking Function including:
a first registration message processing unit for intercepting a message sent from a Visitor Location Register to a Home Location Register, transmitting the message transparently to the Home Location Register, determining whether the message contains information related to a user registration, and if yes, duplicating the message and forwarding the duplicated message to a third-party device; and
a second registration message processing unit for intercepting a message sent from the Home Location Register to the Visitor Location Register, transmitting transparently the message to the Visitor Location Register, determining whether the message contains information related to a user registration, and if yes, g duplicating the message and forwarding the duplicated message to a third-party device.

Moreover, an embodiment of the present invention provides a Signaling Forking Function including:
a first registration message parsing unit for intercepting a message sent from a Visitor Location Register to a Home Location Register, forwarding the message to the Home Location Register, determining whether the message contains information related to user registration, and if yes, extracting the user registration information and informing a third-party device of the extracting result; and
a second registration message parsing unit for intercepting a message sent from the Home Location Register to the Visitor Location Register, forwarding the message to the Visitor Location Register, determining whether the message contains information related to user registration, and if yes, extracting the user registration information and informing a third-party device of the extracting result.

Additionally, an embodiment of the present invention provides an Interwork Gateway including:
a registration information processing unit for obtaining registration information when a terminal registers in a circuit domain or a packet domain; and
a route decision unit for making a route decision corresponding to registration state of the terminal and a predefined policy when a device in the circuit domain or the packet domain triggers a call for the terminal to the Interwork Gateway.

Optionally, the registration information processing unit may further include:
a circuit domain registration information processing unit for obtaining the registration information of the terminal from a Home Location Register, a Visitor Location Register, or a Signaling Forking Function connected between the Home Location Register and the Visitor Location Register; and
a packet domain registration information processing unit for obtaining the registration information from a Call Session Control Function.

It can be seen that, with the inter-domain Interwork Gateway (IWGW), the dual-mode terminal registers respectively with the IWGW when it logins in the circuit domain or the packet domain; a Gateway Mobile Switching Centre (GMSC) or a Call Session Control Function (CSCF) triggers to the IWGM upon receipt of a call for the terminal; the IWGW decides the route according to the registration state and a predefined policy; and the GMSC or CSCF continues the call according the decision result.

A practical policy may be to route the call to a domain where the terminal has a latest login.

An SFF may be added, between an HLR and a VLR, for duplicating and forwarding the interaction signaling between the VLR and the HLR to the IWGW.

In the above mentioned technical solutions, the terminal is enabled to be kept in registration state in two different networks simultaneously, and when a call is required to be connected to the terminal, it is possible for the network to be aware of the specific network, to which the terminal belongs currently, according to the time sequence of the registrations of the terminal in the two networks, and then to decide the route for the call according to an operator or user-defined policy.

In the solutions of the present invention, an SFF is added such that the IWGW can obtain in time the registration information upon the registration of the dual-mode terminal in the CS domain. More importantly, there is no need to make any modification to the existing devices, and only one device is added over the link between the HLR and the VLR. This SFF can be “transparent” to the HLR, the VLR and other existing devices.

### BRIEF DESCRIPTIONS OF THE DRAWINGS

FIG. 1 is a schematic diagram of a registration process for a multi-mode terminal in a packet domain in a VLR-simulated registration model of the prior art;

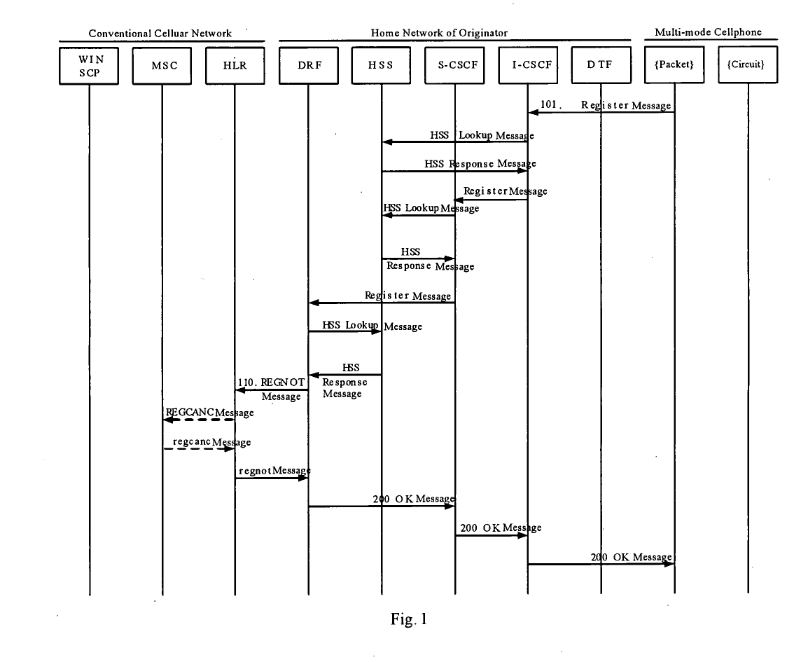

FIG. 2 is a schematic diagram of a registration process for a multi-mode terminal in a circuit domain in a VLR-simulated registration model of the prior art;

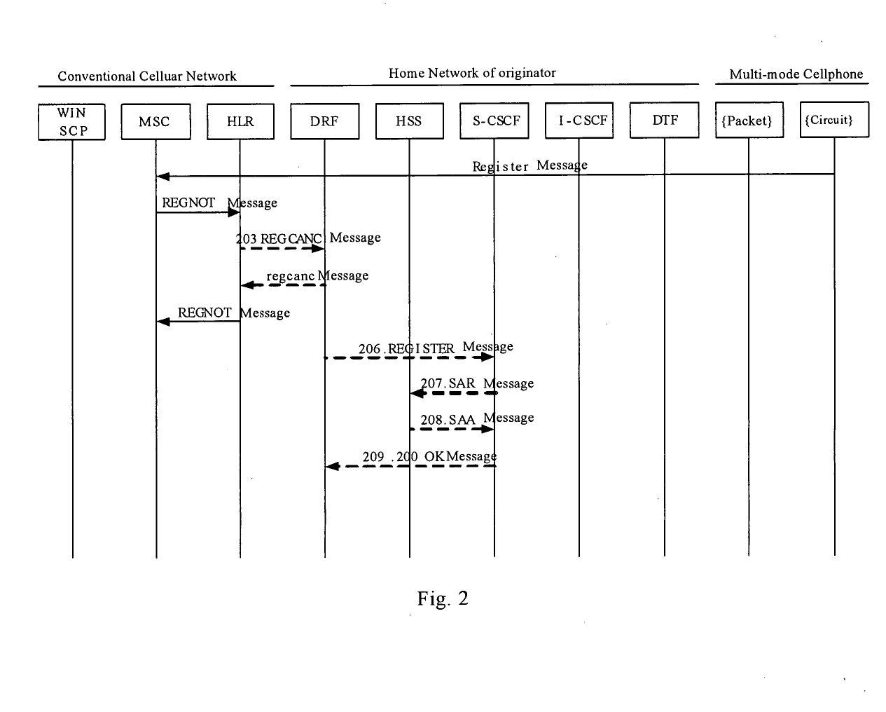

FIG. 3 is a schematic diagram of connection between a IWGM according to an embodiment of the present invention and other devices in a circuit domain and a packet domain;

FIG. 4 is a schematic diagram of a registration process for a dual-mode terminal in an IMS domain according to a preferred embodiment of the present invention;

FIG. 5 is a schematic diagram of a registration process for a dual-mode terminal in an CS domain according to the preferred embodiment of the present invention;

FIG. 6 is a schematic diagram of a process in a case when a call comes from a CS domain while a dual-mode terminal has recently registered in an IMS domain according to the preferred embodiment of the present invention;

FIG. 7 is a schematic diagram of a process in a case when a call comes from an IMS domain while a dual-mode terminal has recent registered in a CS domain according to the preferred embodiment of the present invention;

FIG. 8 is a schematic diagram of networking according to a preferred embodiment of the present invention; and

FIG. 9 is a schematic diagram of a process in a case when a call comes from the CS domain while a dual-mode terminal has recently registered in a CS domain according to a preferred embodiment of the present invention.

### DETAILED DESCRIPTIONS OF THE EMBODIMENTS

The present invention will be further detailed with reference to the drawings.

It shall be noted that, in the embodiments of the present invention, an Interwork Gateway (IWGW), which is disclosed in a patent application No. 200510078750.1 entitled “METHOD FOR IMPLEMENTATION OF INTERWORKING OF DUAL-NETWORKS [symbol] , [symbol] , [symbol] may be adopted, and an improvement in its function may be provided. The whole content of the above mentioned patent application is incorporated herein by reference.

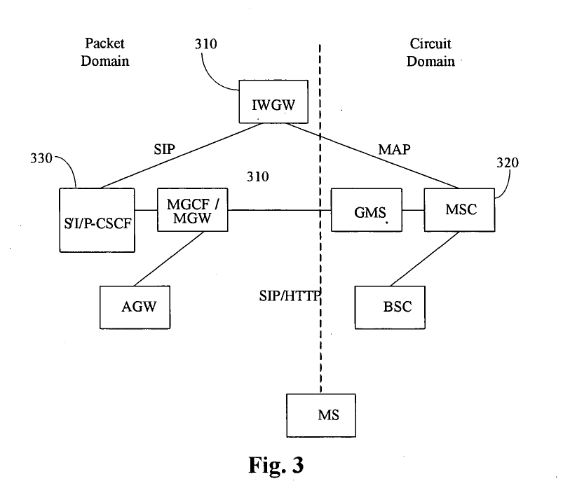

As shown in FIG. 3, a network includes an IWGW 310 connected respectively to a Mobile Switching Centre (MSC) 320 in a circuit domain and an S/I/P Call Session Control Function (S/I/P-CSCF) 330 in a packet domain.

In the circuit domain, the IWGW 310 is equivalent to a Service Control Point (SCP) to which a dual-mode user subscribes, and all incoming or outgoing calls the user makes in the circuit domain are required to be triggered to the IWGW 310. Therefore, the IWGW 310 can keep functioning as a call control in a signaling path of a call.

Furthermore, the IWGW 310 obtains an event of the user's registration in the circuit domain and the specific occurrence time of the registration event through the perception of user registration information sent from the MSC 320 to an HLR (not shown).

In the packet domain, the IWGW 310 is equivalent to an Application Server (AS) to which the dual-mode user subscribes. All information on the user's registration in the IMS domain can be reported to the IGWM 310, and thus the IWGW 310 can be aware of the registration state and the registration time of the user in the IMS domain. Meanwhile, all incoming or outgoing calls that the user makes in the IMS domain are required to be triggered to the IWGW 310, and therefore the IWGW 310 can keep functioning as a call control in a signaling path of a call.

In this case, if the user is in the registration state in both networks, the IWGW 310 may compare the registration time of the user in the HLR of the circuit domain and the registration time of the user in an HSS (not shown) of the IMS domain, and the domain, in which a latest-initiated registration process occurs, may be the one where the user is located.

On the other hand, when the user initiates a call from a certain network to a dual-mode user, the call may be triggered to the IWGW 310. The IWGW 310 can decide its routing direction according to a plurality of decision factors, for example an operator policy, a user policy, a user-specific registration state, etc. A decision for a routing policy depending upon a user-specific registration state is described hereinafter as an example. If the user is in the registration state in only one network, the call may be connected to that network; or if the user is in the registration state in both networks, a judgment may be required as to the latest registration time in the two works, in order to determine a network in which the latest registration occurs. The call may be firstly connected to a network where the latest call occurs. If the user can not be called in that network, the IWGW 310 may determine whether continue to connect the call to the other network in an attempt to get the user called, according to the operator policy or the user-predefined policy.

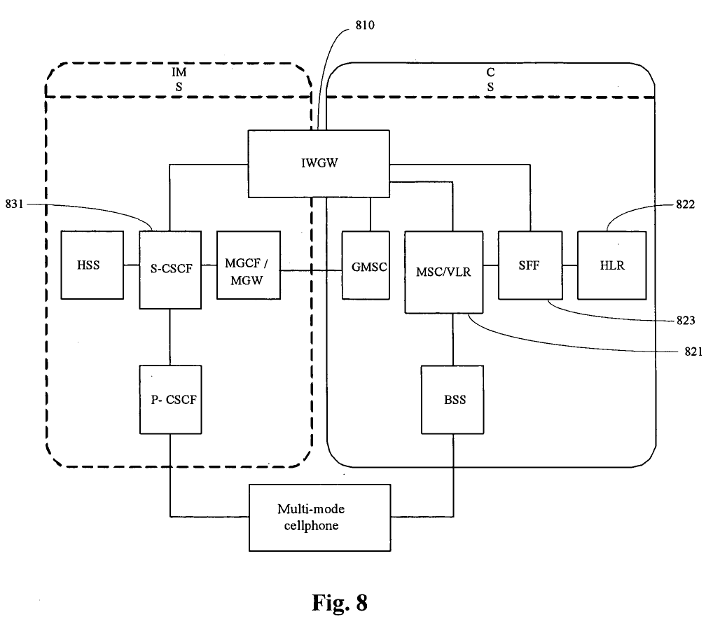

A networking according to a preferred embodiment of the present invention is shown in FIG. 8. In this embodiment, in order to enable a message of a user's registration in a circuit domain to be sent to an IWGW 801, a network entity of Signaling Forking Function (SFF) 823 is further disposed over a signaling link between a VLR 821 and an HLR 822, for duplicating all the messages transmitted between the VLR 821 and the HLR 822 and forwarding the duplicated messages to the IWGW 810. The IWGW 810 sorts the received messages and extracts the user registration message sent from a circuit domain MSC to the HLR for obtaining the event of the user's registration in the circuit domain and the specific time of the registration event. Of course, it is also possible for the SFF 823 to sort the messages in advance, select one or more messages needed by the IWGW 810, and forward the selected messages to the IWGW 810, or inform the IWGW 810 with other messages such as INFO, NOTIFY or the like in the SIP signaling. The SFF 823 may also be integrated with the IWGW 810. Also, the IWGW 810 is connected to the S-CSCF 831 in the packet domain.

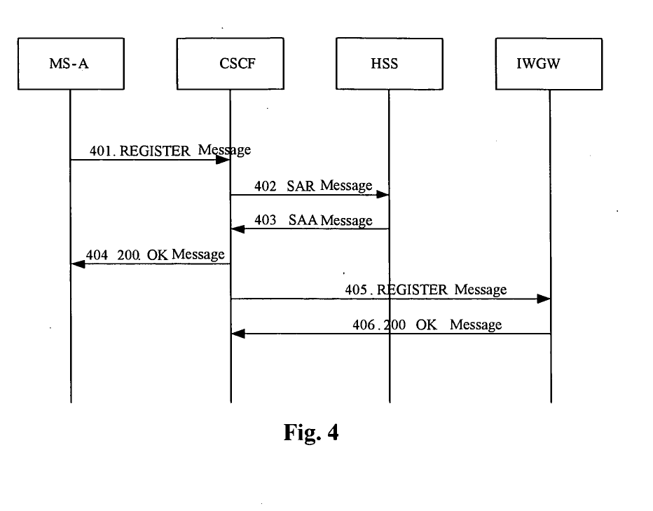

With a CS domain and an IMS domain as examples, an inter-domain routing method for a dual-mode terminal between the CS domain and the IMS domain will be described according to a preferred embodiment of the present invention with reference to FIGS. 4-7.

Referring to FIG. 4, a process for a user's registration in the IMS domain according to the embodiment may include the following steps.

In step 401, a Mobile Station (MS)-A originates a register message “REGISTER” to a Call Session Control Function (CSCF) in the IMS domain. Then in step 402, the CSCF informs an HSS upon the reception of the register message, and asks the HSS for user data. In step 403, the HSS records the user's registration information and returns to the CSCF the user data asked. In step 404, the CSCF sends a “200 OK” message informing the user MS-A of a successful registration. Thereafter in step 405, the CSCF sends a “Register” message to the IWGW. In step 406, the IWGW sends a “200 OK” message to the CSCF.

It shall be essential in this process that, the CSCF initiates a third-party registration to the IWGW informing the IWGW of the registration state of the dual-mode terminal upon the successful completion of a normal registration process.

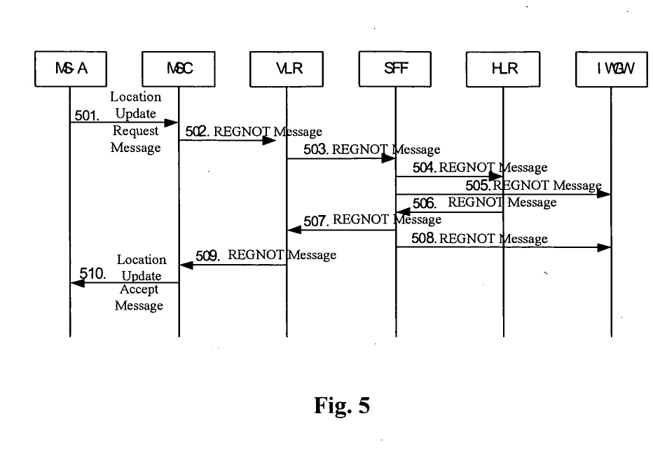

Referring to FIG. 5, a process for a user's registration in the CS domain according to the embodiment may include the following steps.

In step 501, the terminal MS-A sends an A interface message “Location Update Request” to the MSC in the CS domain so as to initiate a registration. In step 502, the MSC sends to the VLR a “REGNOT” message informing the registration event, upon receipt of the A interface message “Location Update Request”. In step 503, the VLR sends to the SFF a “REGNOT” message informing the registration event. In step 504, the SFF sends a “REGNOT” message to the HLR and asks the HLR for user data. In step 505, the SFF duplicates the message and forwarded the duplicated message to the IWGW, the IWGW records the registration event and time of the user. In step 506, the HLR receives the “REGNOT” message and returns to the SFF the user data asked therefrom. In step 507, the SFF receives in the signaling link the “REGNOT” message from the HLR and then sends the message to the VLR. Also in step 508, the SFF generates a duplicate of the response message and forwards the duplicated response message to the IWGW, the IWGW records the result of the user registration. In step 509, the VLR responds to the register message of the MSC in step 502. In step 510, the MSC sends to the user MS-A a “Location Update Accept” message informing the acceptance of the user registration.

It shall be essential in this process that, the SFF “listens” to the interaction messages between the VLR and the HLR, and generates a duplicate of intercepted messages and forwards the duplicated message to the IWGW, such that the IWGW can be duly aware of the registration of the dual-mode terminal in the CS domain. In the solutions of the present invention, with the introduction of the SFF, it is unnecessary to make any modification to the existing devices, and only one device is added and connected on the link between the HLR and the VLR. The SFF may be “transparent” to the HLR, the VLR and the other devices.

It shall be noted that the SFF may be not necessary, and in an alternative embodiment of the present invention, the HLR or the VLR can be adapted to report to the IWGW upon reception a message related to the user registration, and thus the IWGW can also be duly aware of the user registration.

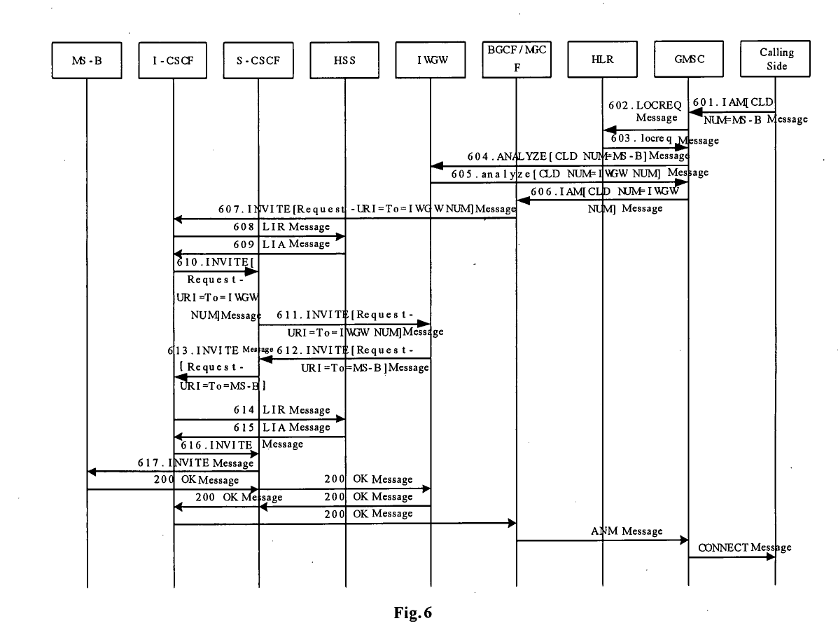

Referring to FIG. 6, according to the embodiment of the present invention, a procedure for processing a call from the CS domain, in the case that the user registers in the IMS domain, may include the following steps.

In step 601, the call arrives at the Gateway Mobile Switching Centre (GMSC) in gateway office of the CS domain. In step 602, the GMSC asks the HLR for user intelligence service data. In step 603, the HLR returns the intelligence service data. In step 604, the GMSC triggers the call to the IWGW. In step 605, the IWGW analyzes the registration state of the user, and modifies the called number to the access number of the IWGW and returns whether the user has a latest registration in the IMS domain. In step 606, the GMSC routes the call to the MGCF. In step 607, the MGCF initiates an “INVITE” message to the I-CSCF. In step 608, the I-CSCF queries in the HSS the user-associated S-CSCF. In step 609, the HSS sends a “LIA” message to the I-CSCF. The HSS may reserve therein a virtual user whose number is the access number of the IWGW, this user needs not to register, but the user subscribes to a service of an unregistered-state and the associated S-CSCF, and the HSS can return this associated S-CSCF at this time. In step 610, the I-CSCF forwards the call to the S-CSCF. In step 611, the S-CSCF triggers the call to the IWGW. The IWGW is required to associate this call with the call previously triggered in the circuit domain. The association can be dependent upon the field of the calling number of the call, or it may be identified depending upon a specific field in the call message. In step 612, the IWGW functioning as a Back to Back User Agent (B2BUA) initiates a new INVITE request to the dual-mode terminal. In step 613, the S-CSCF forwards the call to the I-CSCF. In step 614, the I-CSCF makes a query in the HSS for an associated S-CSCF. In step 615, the HSS returns the user-associated S-CSCF. In step 616, the I-CSCF forwards the call to the associated S-CSCF. In step 617, the S-CSCF calls the user.

It shall be essential in this procedure that, if the IWGW, when trigged by the GMSC, determines that the terminal has a latest registration in the IMS domain but the call comes from the CS domain, the called number of the call may be changed to the access number of the IWGW itself and may be returned to the GMSC; since the called number has been changed to the access number of the IWGW, the CSCF may retrigger to the IWGW, the IWGW initiates a call to the terminal in the IMS domain again by acting as a B2BUA, thus completing the process for routing the call of the CS domain to the terminal of the IMS domain.

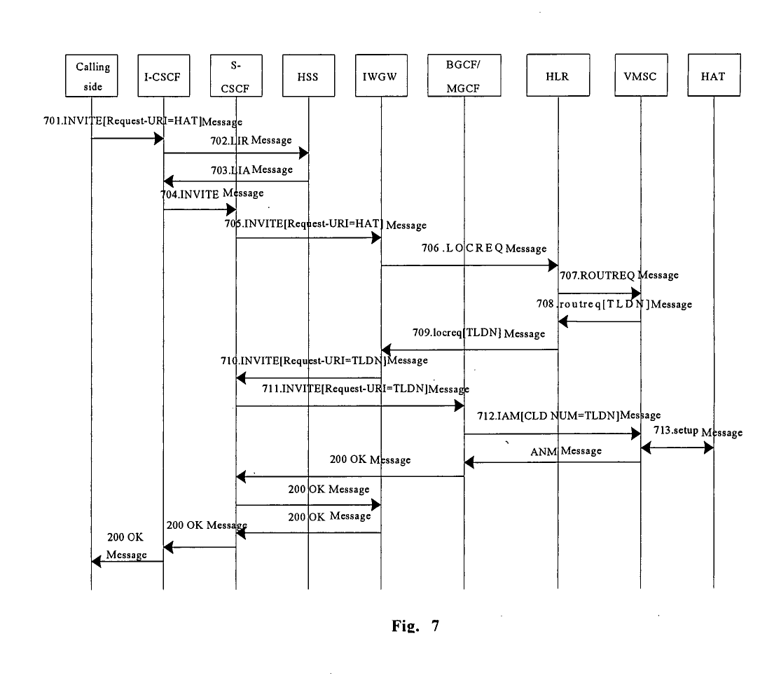

Referring to FIG. 7, according to the embodiment of the present invention, a procedure for processing a call from the IMS domain in the case that the user registers with the CS domain may include the following steps.

In step 701, the call reaches the access point I-CSCF of the IMS domain. In step 702, the I-CSCF asks the HSS for a home S-CSCF of the user. In step 703, the HSS returns information on the home S-CSCF of the user. In step 704, the I-CSCF forwards the call to the S-CSCF. In step 705, the S-CSCF triggers the call to the IWGW according to a trigger to which the user is subscribed. In step 706, the IWGW judges the registration state of the user, and may sends to the HLR of the CS domain a LOCREQ message asking for the location of the user in the CS domain if a decision is made to connect to the user in the CS domain. In step 707, the HLR sends to the VMSC a ROUTREQ message asking for a user Temporary Local Directory Number. In step 708, the VMSC assigns the Temporary Local Directory Number and returns it to the HLR. In step 709, the HLR returns the Temporary Local Directory Number to the IWGW. In step 710, the IWGW acting as the B2BUA reinitiates to the S-CSCF a session in which the called address is the user Temporary Local, Directory Number. In step 711, if the S-CSCF determines according to the user Temporary Local Directory Number that the session needs to be routed to the CS domain, it will send the session to the BGCF/MGCF. In step 712, the BGCF/MGCF routes the call to the VMSC by using the Temporary Local Directory Number as the called number. In step 713, the VMSC starts to connect to the user, followed by a normal procedure for called-connecting in the CS domain, descriptions of which is omitted here.

It shall be essential in this procedure that, in step 706, the IWGW may ask the CS domain directly for the Temporary Local Directory Number if it determines that the present call needs to be connected in the CS domain, and may initiate a new IMS session by using the obtained Temporary Local Directory Number. Thus, a subsequent entity can route the call to the CS domain utilizing the Temporary Local Directory Number.

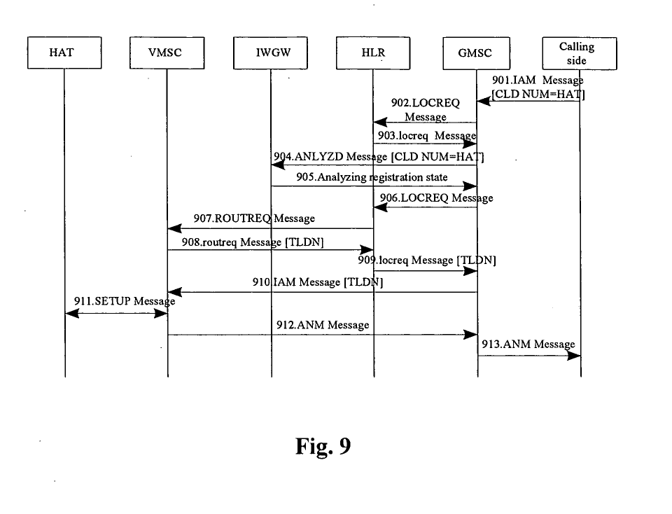

Referring to FIG. 9, a procedure for processing a call from the CS domain in case that the user registers in the CS domain will be described according to the embodiment of the present invention.

In step 901, the call arrives at the Gateway Mobile Switching Centre (GMSC) of gateway office in the CS domain. In step 902, the GMSC asks the HLR for user intelligence service data. In step 903, the HLR returns the intelligence service data. In step 904, the GMSC triggers the call to the IWGW. In step 905, the IWGW analyzes the registration state of the user, and may return directly an instruction of continuing the connection in the CS domain if the user has a latest registration in the CS domain. In step 906, the GMSC asks the HLR for the location of the user. In step 907, the HLR asks a Visited MSC (VMSC) for the user Temporary Local Directory Number (TLDN). In step 908, the VMSC assigns the Temporary Local Directory Number and returns it to the HLR. In step 909, the HLR returns the Temporary Local Directory Number to the GMSC. In step 910, the GMSC routes the call to the VMSC through the Temporary Local Directory Number. In step 911, the connection is started between the VMSC and the dual-mode terminal. In step 912, the VMSC returns an ANM message indicating that the call is put through when the connection to the user is successful. In step 913, the GMSC sends the ANM message to the network of the calling-side.

It shall be essential in this procedure that, in step 905, the IWGW may return the instruction (this instruction can be expressed by returning no parameter) of continuing the connection in the CS domain when it determines that the connection to the called user should be performed in the CS domain. The following procedure is a totally normal procedure for called-connection in the CS domain.

An Interwork Gateway (IWGW) provided according to an embodiment of the present invention may include:
a registration information processing unit for obtaining registration information when a terminal logins in a circuit domain or a packet domain; and
a route decision unit for making a route decision corresponding to a registration state of the terminal and a predefined policy when a device in the circuit domain or the packet domain triggers a call for the terminal to the Interwork Gateway.

Preferably, the registration information processing unit may include:
a circuit domain registration information processing unit for obtaining the registration information of the terminal from a Home Location Register, a Visitor Location Register or a Signaling Forking Function connected between the Home Location Register and the Visitor Location Register; and
a packet domain registration information processing unit for obtaining the registration information from a Call Session Control Function.

A Signaling Forking Function (SFF) according to an embodiment of the present invention may include:
a first message intercepting unit for intercepting a message sent from a Visitor Location Register to a Home Location Register, transmitting the message transparently to the Home Location Register, and duplicating the message and forwarding the duplicated message to a third-party device; and
a second message intercepting unit for intercepting a message sent from a Home Location Register to a Visitor Location Register, transmitting the message transparently to the Visitor Location Register, and duplicating the message and forwarding the duplicated message to a third-party device.

Alternatively, the Signaling Forking Function may include:
a first registration message processing unit for intercepting a message sent from a Visitor Location Register to a Home Location Register, transmitting the message transparently to the Home Location Register, and determining whether the message contains information related to user registration, and if yes, duplicating the message and forwarding the duplicated message to a third-party device; and
a second registration message processing unit for intercepting a message sent from a Home Location Register to a Visitor Location Register, transmitting the message transparently to the Visitor Location Register, and determining whether the message contains information related to user registration, and if yes, duplicating the message and forwarding the duplicated message to a third-party device.

Also alternatively, the Signaling Forking Function may include:
a first registration message parsing unit for intercepting a message sent from a Visitor Location Register to a Home Location Register, forwarding the message to the Home Location Register, determining whether the message contains information related to user registration, and if yes, extracting the user registration information and informing a third-party device of the extracting result; and
a second registration message parsing unit for intercepting a message sent from a Home Location Register to a Visitor Location Register, forwarding the message to the Visitor Location Register, determining whether the message contains information related to user registration, and if yes, extracting the user registration information and informing a third-party device of the extracting result.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

While the present invention has been illustrated and described with reference to some preferred embodiments, those skilled in the art shall recognize that various changes in the form and the detail thereof can be made without departing from the spirit and scope of the present invention as defined by the accompanied claims.

1. An inter-domain routing method for a dual-mode terminal between a circuit domain and a packet domain, comprising the steps of:
obtaining registration information by an Interwork Gateway when the terminal registers in the circuit domain or the packet domain;
triggering a call for the terminal to the Interwork Gateway when a device in the circuit domain or the packet domain receives the call;
making a route decision by the Interwork Gateway according to the registration information and a predefined policy; and
continuing the call when the device in the circuit domain or the packet domain receives the decision from the Interwork Gateway.

2. The inter-domain routing method according to claim 1, after the step of making the route decision, further comprising the steps of:
in the case that the terminal has a latest registration in the circuit domain and the call comes from the packet domain, obtaining a Temporary Local Directory Number of the terminal from a Home Location Register by the Interwork Gateway after the Interwork Gateway is triggered by a Call Session Control Function, and reinitiating a request, in which the requested address is the Temporary Local Directory Number of the terminal, by the Interwork Gateway acting as a Back to Back User Agent.

3. The inter-domain routing method according to claim 1, after the step of making the route decision, further comprising the steps of:
modifying the called number of the call into an access number of the Interwork Gateway and returning the modified number to a Gateway Mobile Switching Centre after the Interwork Gateway is triggered by the Gateway Mobile Switching Centre, in the case that the terminal has a latest registration in the packet domain and the call comes from the circuit domain; and
the step of continuing the call comprises the steps of:
associating this call with the call triggered by the Gateway Mobile Switching Centre, and initiating a new request to the terminal by the Interwork Gateway acting as a Back to Back User Agent, when the call is routed to the Interwork Gateway by the Call Session Control Function.

4. The inter-domain routing method according to claim 3, wherein the associating is performed by the Interwork Gateway through a calling number field of the call or a predesignated field in a call message.

5. The inter-domain routing method according to claim 1, after the step of making the route decision, further comprising the steps of:
returning an instruction of continuing the connection in the CS domain by the Interwork Gateway after the Interwork Gateway is triggered by a Gateway Mobile Switching Centre, in the case that the terminal has a latest registration in the circuit domain and the call comes from the circuit domain.

6. The inter-domain routing method according to claim 5, wherein the step of continuing the call comprises the steps of:
obtaining a Temporary Local Directory Number, which is assigned by a Visited Network Mobile Switching Centre in which the user terminal is located, by the Gateway Mobile Switching Centre through a user Home Location Register when the Gateway Mobile Switching Centre receives the instruction of continuing the connection in the CS domain, and connecting the call to the Visited Network Mobile Switching Centre which connects to the user in the circuit domain.

7. The inter-domain routing method according to claim 1, wherein the packet domain is an Internet Protocol Multimedia Subsystem domain.

8. The inter-domain routing method according to claim 2, wherein the packet domain is an Internet Protocol Multimedia Subsystem domain.

9. The inter-domain routing method according to claim 1, wherein the predefined policy is an operator policy, or a user policy, or a combination of the operator policy and the user policy.

10. The infer-domain routing method according to claim 2, wherein the predefined policy is an operator policy, or a user policy, or a combination of the operator policy and the user policy.

11. The inter-domain routing method according to claim 9, wherein the operator policy or the user policy is to route the call to a domain in which the terminal has a latest registration.

12. The inter-domain routing method according to claim 10, wherein the operator policy or the user policy is to route the call to a domain in which the terminal has a latest registration.

13. The inter-domain routing method according to claim 1, wherein the registration of the terminal in the circuit domain comprises the steps of:
during the registration, obtaining by the Interwork Gateway a message which is transmitted between a Visitor Location Register and a Home Location Register, and extracting and recording the user registration information if the message contains information related to the user registration; or
obtaining and recording by the Interwork Gateway information related to the user registration contained in a message which is transmitted between a Visitor Location Register and a Home Location Register.

14. The inter-domain routing method according to claim 2, wherein the registration of the terminal in the circuit domain comprises the steps of:
during the registration, obtaining by the Interwork Gateway a message which is transmitted between a Visitor Location Register and a Home Location Register, and extracting and recording the user registration information if the message contains information related to the user registration; or
obtaining and recording by the Interwork Gateway information related to the user registration contained in a message which is transmitted between a Visitor Location Register and a Home Location Register.

15. The inter-domain routing method according to claim 1, wherein a Signaling Forking Function is added on a signaling link between a Visitor Location Register and a Home Location Register in the circuit domain, for duplicating a received message and forwarding the duplicated message to the Interwork Gateway; and
the registration of the terminal in the circuit domain comprises the steps of:
during the registration, forwarding a message, which is sent from the Visitor Location Register to the Home Location Register, to the Home Location Register in the case that the Signaling Forking Function intercepts the message, duplicating the message and forwarding the duplicated message to the Interwork Gateway;
during the registration, forwarding a message, which is sent from the Home Location Register to the Visitor Location Register, to the Visitor Location Register in the case that the Signaling Forking Function intercepts the message, duplicating the message and forwarding the duplicated message to the Interwork Gateway; and
determining by the Interwork Gateway whether the message contains information related to the user registration, and extracting and recording the user registration information, when the Interwork Gateway receives the message of the terminal from the Signaling Forking Function.

16. The inter-domain routing method according to claim 2, wherein a Signaling Forking Function is added on a signaling link between a Visitor Location Register and a Home Location Register in the circuit domain, for duplicating a received message and forwarding the duplicated message to the Interwork Gateway; and
the registration of the terminal in the circuit domain comprises the steps of:
during the registration, forwarding a message, which is sent from the Visitor Location Register to the Home Location Register, to the Home Location Register in the case that the Signaling Forking Function intercepts the message, duplicating the message and forwarding the duplicated message to the Interwork Gateway;
during the registration, forwarding a message, which is sent from the Home Location Register to the Visitor Location Register, to the Visitor Location Register in the case that the Signaling Forking Function intercepts the message, duplicating the message and forwarding the duplicated message to the Interwork Gateway; and
determining by the Interwork Gateway whether the message contains information related to the user registration, and extracting and recording the user registration information, when the Interwork Gateway receives the message of the terminal from the Signaling Forking Function.

17. The inter-domain routing method according to claim 1, wherein a Signaling Forking Function is added over a signaling link between a Visitor Location Register and a Home Location Register in the circuit domain, for selecting a message containing information related to the user registration among the received messages, duplicating the message and forwarding the duplicated message to the Interwork Gateway; and
the registration of the terminal in the circuit domain comprises the steps of:
during the registration, forwarding a message, which is sent from the Visitor Location Register to the Home Location Register, to the Home Location Register if the Signaling Forking Function intercepts the message, determining whether the message contains information related to the user registration, and if yes, duplicating the message and forwarding the duplicated message to the Interwork Gateway;
during the registration, forwarding a message, which is sent from the Home Location Register to the Visitor Location Register, to the Visitor Location Register in the case that the Signaling Forking Function intercepts the message, determining whether the message contains information related to the user registration, and if yes, duplicating the message and forwarding the duplicated message to the Interwork Gateway; and
extracting and recording the user registration information by the Interwork Gateway when the Interwork Gateway receives the message of the terminal from the Signaling Forking Function.

18. The inter-domain routing method according to claim 2, wherein a Signaling Forking Function is added over a signaling link between a Visitor Location Register and a Home Location Register in the circuit domain, for selecting a message containing information related to the user registration among the received messages, duplicating the message and forwarding the duplicated message to the Interwork Gateway; and
the registration of the terminal in the circuit domain comprises the steps of:
during the registration, forwarding a message, which is sent from the Visitor Location Register to the Home Location Register, to the Home Location Register if the Signaling Forking Function intercepts the message, determining whether the message contains information related to the user registration, and if yes, duplicating the message and forwarding the duplicated message to the Interwork Gateway;
during the registration, forwarding a message, which is sent from the Home Location Register to the Visitor Location Register, to the Visitor Location Register in the case that the Signaling Forking Function intercepts the message, determining whether the message contains information related to the user registration, and if yes, duplicating the message and forwarding the duplicated message to the Interwork Gateway; and
extracting and recording the user registration information by the Interwork Gateway when the Interwork Gateway receives the message of the terminal from the Signaling Forking Function.

19. The inter-domain routing method according to claim 1, wherein a Signaling Forking Function is added over a signaling link between a Visitor Location Register and a Home Location Register in the circuit domain, for extracting user registration information upon the receipt of a message and for informing the Interwork Gateway of the extracting result; and
the registration of the terminal in the circuit domain comprises the steps of:
during the registration, forwarding a message, which is sent from the Visitor Location Register to the Home Location Register, to the Home Location Register if the Signaling Forking Function intercepts the message, determining whether the message contains information related to the user registration, and if yes, extracting the user registration information and informing the Interwork Gateway of the extracting result;
during the registration, forwarding a message, which is sent from the Home Location Register to the Visitor Location Register, to the Visitor Location Register in the case that the Signaling Forking Function intercepts the message, determining whether the message contains information related to the user registration, and if yes, extracting the user registration information and informing the Interwork Gateway of the extracting result; and
recording the user registration result by the Interwork Gateway when the Interwork Gateway receives the user registration information from the Signaling Forking Function.

20. The inter-domain routing method according to claim 2, wherein a Signaling Forking Function is added over a signaling link between a Visitor Location Register and a Home Location Register in the circuit domain, for extracting user registration information upon the receipt of a message and for informing the Interwork Gateway of the extracting result; and
the registration of the terminal in the circuit domain comprises the steps of:
during the registration, forwarding a message, which is sent from the Visitor Location Register to the Home Location Register, to the Home Location Register if the Signaling Forking Function intercepts the message, determining whether the message contains information related to the user registration, and if yes, extracting the user registration information and informing the Interwork Gateway of the extracting result;
during the registration, forwarding a message, which is sent from the Home Location Register to the Visitor Location Register, to the Visitor Location Register in the case that the Signaling Forking Function intercepts the message, determining whether the message contains information related to the user registration, and if yes, extracting the user registration information and informing the Interwork Gateway of the extracting result; and
recording the user registration result by the Interwork Gateway when the Interwork Gateway receives the user registration information from the Signaling Forking Function.

21. A system for obtaining registration information of a user in a circuit domain, comprising a Home Location Register, a Visitor Location Register and a third-party device which needs to obtain the registration information, wherein the system further comprises, a Signaling Forking Function in a signaling link connected between the Visitor Location Register and the Home Location Register, for sending data including the registration information to the third-party device according to a predefined policy while transmitting an interaction message transparently between the Visitor Location Register and the Home Location Register.

22. The system according to claim 21, wherein the predefined policy is one of:
the Signaling Forking Function duplicating all the received messages and forwarding them to the third-party device, among which the third-party device selects a registration-related message;
the Signaling Forking Function selecting a registration-related message among received messages, and duplicating this message and forwarding the duplicated message to the third-party device; and
the Signaling Forking Function parsing the received messages and forwarding the obtained registration information to the third-party device.

23. The system according to claim 21, wherein the third-party device is an Interwork Gateway; and
the third-party device and the Signaling Forking Function are located in the same physical entity or two separate physical entities.

24. The system according to claim 22, wherein the third-party device is an Interwork Gateway; and
the third-party device and the Signaling Forking Function are located in the same physical entity or two separate physical entities.

25. A method for obtaining registration information of a user in a circuit domain, comprising the steps of:
transmitting a message, which is sent from the Visitor Location Register to the [symbol] Home Location Register, transparently to the Home Location Register when a Signaling Forking Function intercepts the message, and duplicating the message and forwarding the duplicated message to a third-party device;
transmitting a message, which is sent from the Home Location Register to the Visitor Location Register, transparently to the Visitor Location Register when the Signaling Forking Function intercepts the message, and duplicating the message and forwarding the duplicated message to the third-party device; and
determining by the third-party device whether the message contains information related to the user registration when the third-party device receives the message from the Signaling Forking Function, and if yes, processing the message.

26. A method for obtaining registration information of a user in a circuit domain, comprising the steps of:
transmitting a message, which is sent from the Visitor Location Register to the Home Location Register, transparently to the Home Location Register when the Signaling Forking Function intercepts the message, determining whether the message contains information related to the user registration, and if yes, duplicating the message and forwarding the duplicated message to the third-party device; and
transmitting a message, which is sent from the Home Location Register to the Visitor Location Register, transparently to the Visitor Location Register when the Signaling Forking Function intercepts the message, determining whether the message contains information related to the user registration, and if yes, duplicating the message and forwarding the duplicated message to the third-party device.

27. A method for obtaining registration information of a user in a circuit domain, comprising the steps of:
forwarding a message, which is sent from the Visitor Location Register to the Home Location Register, to the Home Location Register when the Signaling Forking Function intercepts the message, determining whether the message contains information related to the user registration, and if yes, extracting the user registration information and informing the third-party device of the extracting result; and
forwarding a message, which is sent from the Home Location Register to the Visitor Location Register, to the Visitor Location Register when the Signaling Forking Function intercepts the message, determining whether the message contains information related to the user registration, and if yes, extracting the user registration information and informing the third-party device of the extracting result.

28. A Signaling Forking Function comprising:
a first message intercepting unit for intercepting a message sent from a Visitor Location Register to a Home Location Register, transmitting the message transparently to the Home Location Register, duplicating the message and forwarding the duplicated message to a third-party device; and
a second message intercepting unit for intercepting a message sent from the Home Location Register to the Visitor Location Register, transmitting the message transparently to the Visitor Location Register, duplicating the message and forwarding the duplicated message to a third-party device.

29. A Signaling Forking Function comprising:
a first registration message processing unit for intercepting a message sent from a Visitor Location Register to a Home Location Register, transmitting the message transparently to the Home Location Register, determining whether the message contains information related to a user registration, and if yes, duplicating the message and forwarding the duplicated message to a third-party device; and
a second registration message processing unit for intercepting a message sent from the Home Location Register to the Visitor Location Register, transmitting transparently the message to the Visitor Location Register, determining whether the message contains information related to a user registration, and if yes, g duplicating the message and forwarding the duplicated message to a third-party device.

30. A Signaling Forking Function comprising:
a first registration message parsing unit for intercepting a message sent from a Visitor Location Register to a Home Location Register, forwarding the message to the Home Location Register, determining whether the message contains information related to user registration, and if yes, extracting the user registration information and informing a third-party device of the extracting result; and
a second registration message parsing unit for intercepting a message sent from the Home Location Register to the Visitor Location Register, forwarding the message to the Visitor Location Register, determining whether the message contains information related to user registration, and if yes, extracting the user registration information and informing a third-party device of the extracting result.

31. An Interwork Gateway comprising:
a registration information processing unit for obtaining registration information when a terminal registers in a circuit domain or a packet domain; and
a route decision unit for making a route decision corresponding to registration state of the terminal and a predefined policy when a device in the circuit domain or the packet domain triggers a call for the terminal to the Interwork Gateway.

32. The Interwork Gateway according to claim 31, wherein the registration information processing unit comprises:
a circuit domain registration information processing unit for obtaining the registration information of the terminal from a Home Location Register, a Visitor Location Register, or a Signaling Forking Function connected between the Home Location Register and the Visitor Location Register; and
a packet domain registration information processing unit for obtaining the registration information from a Call Session Control Function.
